(19) United States
(12) Patent Application Publication
(10) Pub. No.: US 2024/0331562 A1
(43) Pub. Date: Oct. 3, 2024

(54) METHOD AND SYSTEM FOR QUESTION/ANSWER GENERATION IN A LEARNING MANAGEMENT SYSTEM

(71) Applicant: D2L Corporation, Kitchener (CA)

(72) Inventors: Brian CEPURAN, Kitchener (CA); Jeremy AUGER, Kitchener (CA)

(21) Appl. No.: 18/620,304

(22) Filed: Mar. 28, 2024

Related U.S. Application Data
(60) Provisional application No. 63/493,549, filed on Mar. 31, 2023.

(51) Int. Cl. G09B 7/04; G09B 7/07

(52) U.S. Cl. CPC G09B 7/04; G09B 7/07

(57) ABSTRACT

A method and system for automated question generation in a learning management system. The method including: receiving a question generation request, wherein the question generation request relates to a course; analyzing course material for the course related to the question generation request; and generating questions based on the analysis and predetermined parameters. The system including: a processor; a memory for storing computer readable instructions, which, when executed by the processor, generate the following modules: a question generation system for receiving a question generation request, wherein the question generation request relates to a course; a question configuration module for analyzing course material for the course related to the question generation request; and an automatic question setting module for generating questions based on the analysis and predetermined parameters.

### FIELD

The present disclosure relates generally to educational technology, including learning management systems. More particularly, the present disclosure relates to a method and system for question/answer generation in a learning management system using an AI.

### BACKGROUND

Learning management systems (“LMS”) are becoming more popular for delivery of educational material in many different situations, whether in conventional areas like public/private educational institutions all the way through to corporations providing internal training to their employees. Some LMSs merely track student registration and progress while others deliver course content and materials directly to students.

With the rapid increase of LMSs and the organizations that use them and provide educational content, there is also an increase in the number and variety of courses being offered and available to learners. In this situation, the process of creating high-quality questions for assessments (and the answers thereto) can be time-consuming and challenging for instructors. Furthermore, students often struggle with retaining the information they learn due to the lack of engagement in the learning process.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a system and method for an AI-powered question generator for a learning management system (LMS) that utilizes artificial intelligence tools, such as large language models, to generate high-quality questions and answers for educational courses in an LMS.

According to another aspect herein, there is provided a method for automated question generation in a learning management system, the method including: receiving a question generation request, wherein the question generation request relates to a course; analyzing course material for the course related to the question generation request; and generating questions based on the analysis and predetermined parameters.

In some cases, the method may further include generating answers to the generated questions.

In some cases, the method may further include, prior to analyzing course material, determining if the question generation request is to be semi-automatic, and, if so, requesting parameters for question generation.

In some cases, the question generation request may include a student name, further including accessing information on the student.

In some cases, the method may further include: monitoring for answers to the generated questions; evaluating the answers; and providing feedback based on the evaluation of the answers.

In some cases, the predetermined parameters can be adjusted after question generation and new questions will be generated.

In some cases, the predetermined parameters may include at least one of question types, number of questions, level of questions, and number or level of each type of question.

In some cases, the analyzing the course material may include determining the concepts and topics to be covered by the generated questions.

According to another aspect herein, there is provided a system for automated question generation in a learning management system, the system including: a processor; a memory for storing computer readable instructions, which, when executed by the processor, generate the following modules: a question generation system for receiving a question generation request, wherein the question generation request relates to a course; a question configuration module for analyzing course material for the course related to the question generation request; and an automatic question setting module for generating questions based on the analysis and predetermined parameters.

In some cases, the automatic question setting module may also generate answers to the generated questions.

In some cases, the question generation system further determines if the question generation request is to be semi-automatic, and, if so, may further include a semi-automatic question setting module configured to request parameters for question generation.

In some cases, the question generation request may include a student name, and the system may further include a real-time question module configured to access information on the student.

In some cases, the system may further include a real-time question module configured to: monitor for answers to the generated questions; evaluate the answers; and provide feedback based on the evaluation of the answers.

In some cases, the question generation system may be configured so that predetermined parameters can be adjusted after question generation and new questions will be generated.

In some cases, the predetermined parameters may include at least one of question types, number of questions, level of questions, and number or level of each type of question.

In some cases, the analyzing the course material may include determining the concepts and topics to be covered by the generated questions.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates an example of a learning management system;

FIG. 2 illustrates an example of a computing device for communication with the learning management system of FIG. 1;

FIG. 3 illustrates a question generation system according to an embodiment herein;

FIG. 4 illustrates a method for question generation according to an embodiment herein; and

FIG. 5 illustrates a method for question generation according to another embodiment herein.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not intended to be limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for course registration. In particular, the embodiments of the system and method detailed herein provide for a method and system for course registration that includes access to promotional material, checking of pre-requisites/approval, and immediate registration for those with pre-requisites/approval.

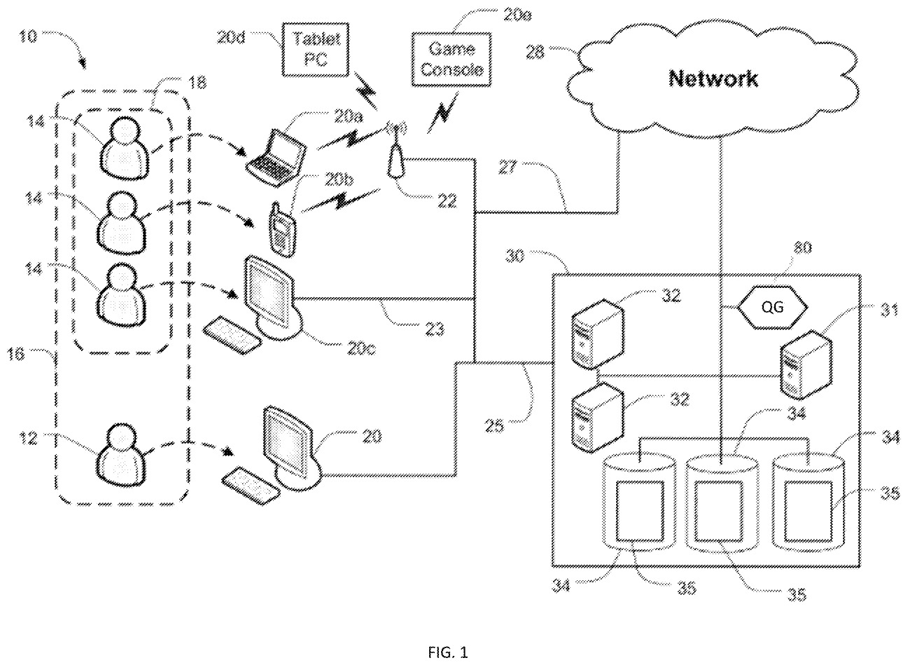

FIG. 1 illustrates an example embodiment of a learning management system 10 according to one embodiment. The learning management system 10 includes an educational service provider system 30, which can be accessed by various users 12, 14 via computer networks.

The users 12, 14 communicate with the educational service provider system 30 either directly or indirectly using any suitable computing device 20, such as, for example a desktop computer that has at least one input device (e.g., a keyboard and a mouse) and at least one output device (e.g., a display screen and speakers). Other examples of the computing device may include: a laptop 20a wirelessly coupled to an access point 22 (e.g., a wireless router, a cellular communications tower, etc.), a wirelessly enabled mobile device, smart phone or the like 20b, a terminal 20c over a wired connection 23, a tablet computer 20d, or a game console 20e over a wireless connection. The computing devices 20 may be connected to the educational service provider system 30 via any suitable communications channel. For example, the computing devices 20 may communicate to the educational service provider system 30 directly through a LAN/intranet or wireless network via a data connection 25, or using an external network, such as, for example, the Internet 28 over a data connection 27.

In some cases, one or more of the users 12 and 14 may be required to authenticate their identities in order to communicate with the educational service provider system 30. For example, the users 12 and 14 may be required to input a login name and/or a password or otherwise identify themselves to gain access to the learning management system 10. In other cases, one or more users (e.g., “guest” users) may be able to access the learning management system 10 without authentication. Such guest users may be provided with limited access, such as the ability to review only one or a few components of the course, for example, to decide whether they would like to enroll in a particular course.

The educational service provider system 30 generally includes a number of components for facilitating the provision of electronic learning services. For example, the educational service provider system 30 generally includes one or more processing devices 32 (e.g., servers), each having one or more processors. The processing devices 32 are configured to send information (e.g., HTML or other data) to be displayed on one or more computing devices 20, 20a, 20b and/or 20c to facilitate social electronic learning (e.g., course information). In some cases, the processing device 32 may be a computing device 20 (e.g., a laptop or a personal computer).

The educational service provider system 30 also generally includes one or more data storage devices 34 (e.g., memory, etc.) that are in communication with the processing devices 32, and could include a relational database (such as an SQL database), or other suitable data storage devices. The data storage devices 34 are configured to host data 35 relating to the courses offered by the service provider.

For example, the data 35 can include course frameworks, educational materials to be consumed by the users 14, historical records about assessments or grades of users 14 or assignments completed by the users 14, as well as various other information.

The data storage devices 34 may also store authorization criteria that define which actions may be taken by the users 12 and 14. In some cases, the authorization criteria may include at least one security profile associated with at least one role. For example, one role could be defined for users who are primarily responsible for developing an educational course, teaching it, and assessing work product from students of the course. Users with such a role may have a security profile that allows them to configure various components of the course, to post assignments, to add assessments, to evaluate performance, and so on.

In some cases, some of the authorization criteria may be defined by specific users 40 who may or may not be part of the educational community 16. For example, users 40 may be permitted to administer and/or define global configuration profiles for the learning management system 10, define roles within the learning management system 10, set security profiles associated with the roles, and assign roles to particular users 12, 14 who use the learning management system 10. In some cases, the users 40 may use another computing device (e.g., a desktop computer 42) to accomplish these tasks.

The data storage devices 34 may also be configured to store other information, such as personal information about the users 12, 14 of the learning management system 10, information about which courses the users 14 are enrolled in, roles to which the users 12 and 14 are assigned, particular interests of the users 12, 14, and historical information about the performance of the users 12, 14.

The processing devices 32 and data storage devices 34 may also provide other electronic learning management tools (e.g., allowing users to add and drop courses, communicate with other users using chat software, etc.), and/or may be in communication with one or more other vendors that provide various tools.

In some cases, the educational service provider system 30 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example. The backup servers 31 could be located at a remote storage location and the service provider system 30 could connect to the backup server 31 using a secure communications protocol to ensure that the confidentiality of the data 35 is maintained.

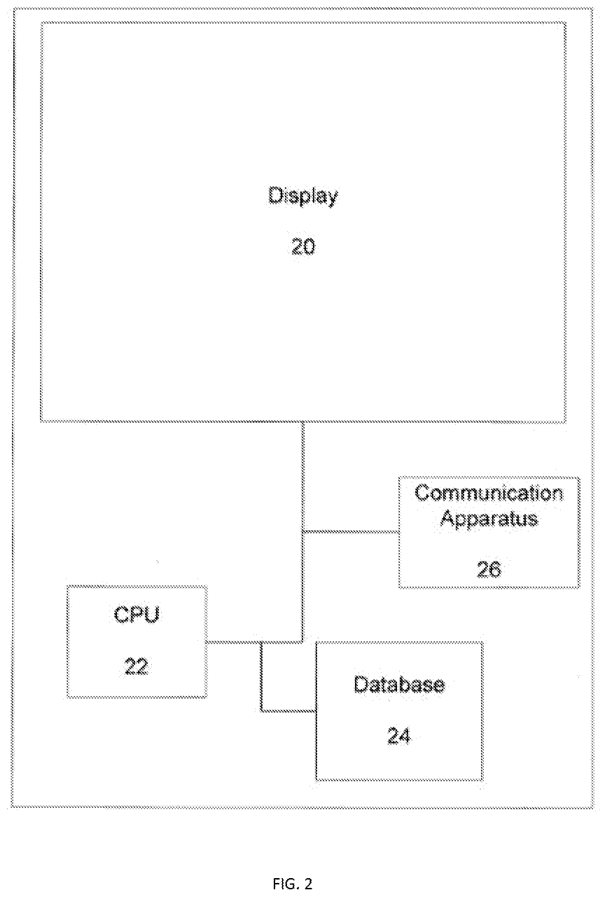

FIG. 2 is a schematic diagram of an example computing device 20, in this case, a mobile computing device, which communicates wirelessly. As shown, the computing device 20 comprises a processor 22, a memory 24, a communication apparatus 26, a display 28, and an input apparatus 29. A user 12, 14, uses the functions of the computing device 20 to communicate with the educational service provider system 30 as described herein.

Generally speaking, the users 12, 14 can use the learning management system 10 to communicate with the educational service provider system 30 to participate in, create, and consume electronic learning services, including enrolling in and participating in various educational courses. In some cases, the educational service provider system 30 may be part of or associated with a traditional “bricks and mortar” educational institution (e.g., an elementary school, a high school, a university or a college), another entity that provides educational services (e.g., an online university, a company that specializes in offering training courses, or an organization that has a training department), or an independent service provider (e.g., for providing individual electronic learning).

It should be understood that a “course” is not necessarily limited to formal courses offered by formal educational institutions. The course may generally include any form of learning instruction offered by an entity of any type. For example, the course may be a training seminar at a company for a small group of employees, a professional certification program with a larger number of intended participants (e.g., PMP, CMA, etc.), and so on.

It should also be understood that users 12, 14 may fall into various categories, including students, instructors, guests, or the like. Further, one or more educational groups can be defined that involve one or more of the users 12, 14. For example, as shown in FIG. 1, the users 12, 14 may be grouped together in an educational group 16 representative of a particular course (e.g., History 101, French 254), in which the first user 12 is an “instructor” and is responsible for providing the course (e.g., organizing lectures, preparing assignments, creating educational content, etc.), while the other users 14 are “learners” or “students” that consume the course content (e.g., the users 14 are enrolled in the course to learn the course content). In some cases, the users 12, 14 may be associated with more than one educational group. For instance, the users 14 may be enrolled in more than one course, while the user 12 may be enrolled in a course and also responsible for teaching a course (which is common for example for graduate students).

In some cases, educational sub-groups may also be defined. For example, in FIG. 1, some users 14 are shown as part of an educational sub-group 18. The sub-group 18 may be defined in relation to a particular project or assignment (e.g., sub-group 18 may be a lab group) or based on other criteria. In some cases, due to the nature of electronic learning, the users 14 in a particular sub-group 18 need not physically meet but may collaborate together using various tools provided by the educational service provider system 30.

In some cases, the groups 16 and sub-groups 18 could include users 12, 14 that share common interests (e.g., interests in a particular sport), that participate in common activities (e.g., users that are members of a choir or a club), and/or have similar attributes (e.g. users that are male, users under twenty-one years of age, etc.).

As shown in FIG. 1, the educational service provider system 30 can include a question generation system 80, which generates questions and/or answers for courses using artificial intelligence of various types.

The question generation system 80 utilizes artificial intelligence tools, such as large language models (LLM), to generate questions and/or answers (in the following the text references to generation/configuration of questions can equally apply to generation/configuration of answers to the questions) for educational courses in the LMS. The question generation system is intended to assist instructors in creating engaging and challenging assessments that promote active learning and knowledge retention.

Generally, the question generation system can offer at least two options for generating questions. As a first option, the question generation system can automatically determine questions to be generated for an assessment based on the course material and learning objectives. The system analyzes the course material and determines the concepts and topics that need to be covered in the assessment. The question generation system then generates questions in various formats, such as multiple choice, true or false, fill in the blank, and math computation, based on the identified concepts and topics.

As a second option, the instructor can define the question or type of question and use the question generation system to automatically generate questions or question/answer pairs. The instructor can define the question format, difficulty level, and topic, and the question generation system generates answers or question/answer pairs based on the input.

In some embodiments, the generated questions can be customizable, allowing instructors to modify the difficulty level, topic coverage, and question type based on their teaching needs. The question generation system is intended to provide a wide range of question types, including multiple choice, true or false, fill in the blank, math computation, and the like. In various embodiments, instructors can choose from a selection of pre-defined question formats or create their own.

In addition to generating questions, the question generation system or learning management system can be configured to provide real-time questions and/or answers to students such that the students receive real-time feedback, allowing the students to assess their knowledge and track their progress. In some cases, the system can automatically analyze the student's performance data to provide personalized recommendations for learning paths. This feature enables instructors to tailor their teaching approach to meet the individual needs of their students, promoting a more effective and efficient learning experience.

The learning management system and question generation system can provide benefits for both instructors and students, including streamlining the process of creating assessments, saving instructors time and allowing them to focus on teaching. The generated questions can be configured to be engaging and challenging, promoting active learning and knowledge retention. Further, the ability to provide real-time feedback to students allows the students to assess their knowledge and track their progress, while the personalized learning paths feature enables instructors to tailor their teaching approach to meet the individual needs of their students.

The flexibility of the question generation system to generate questions automatically or to allow instructors to define their own questions and have answers generated automatically provides customization and convenience. AIlowing for multiple question formats can provide diverse and varied assessments, and the automatic generation of answers helps to reduce the workload on the instructor.

Embodiments of the learning management system and question generation system herein are intended to create engaging and challenging assessments for educational courses and promote active learning and knowledge retention.

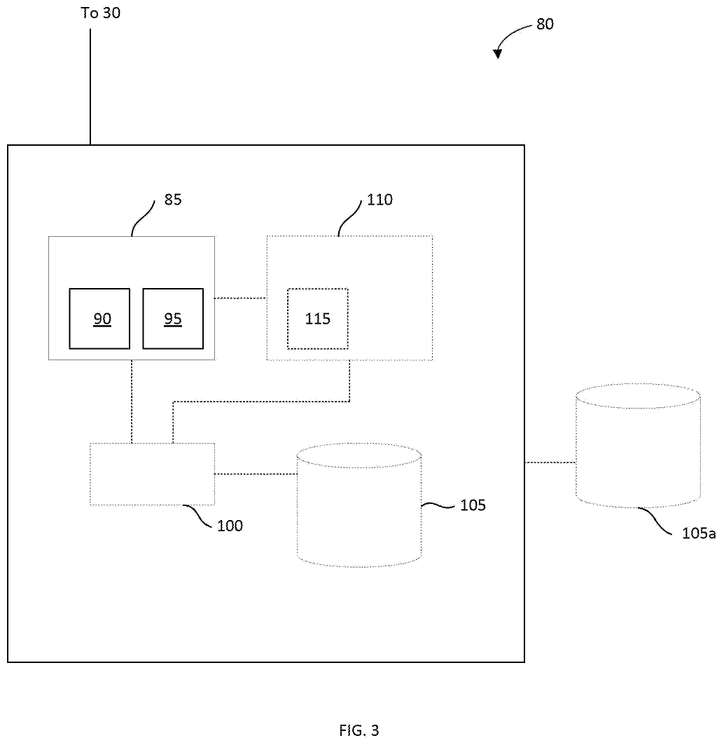

FIG. 3 illustrates a block diagram of the question generation system 80 according to one embodiment. It will be understood that other embodiments are available to one of skill in the art on consideration of the above general description and the present example embodiment. The question generation system 80 is operable to communicate with a user via, for example, the learning management system 10 and a computing device 20. The question generation system 80 may include its own processor 100 and memory storage/database 105, containing an AI repository/LLM or the like, or may rely on those available through the educational service provider system 30 or otherwise. FIG. 3 illustrates an external memory/database 105a that can be accessed by the question generation system 80. The question generation system 80 includes a question configuration module 85, which allows a course creator to generate/configure questions. In this embodiment, the question configuration module 85 includes an automatic question setting module 90 and/or a semi-automatic question setting module 95. In some embodiments, the question generation system 80 may also include a real-time question module 110 for use by learners accessing the question generation system 80 via the educational service provider system 30. The real-time question module 110 is configured to present questions/answers in real time to learners interested in evaluating their knowledge. In particular, the real-time question module 110 may make use of questions/answers previously generated by the question configuration system 85 or may generate new questions in real-time. As with other modules, the questions may be in various formats, such as written answer, multiple choice, or the like. The real-time question module 110 may include a student evaluation module 115 that uses AI tools to monitor student performance on questions and is configured to provide feedback to students on areas that need additional study based on answers to questions.

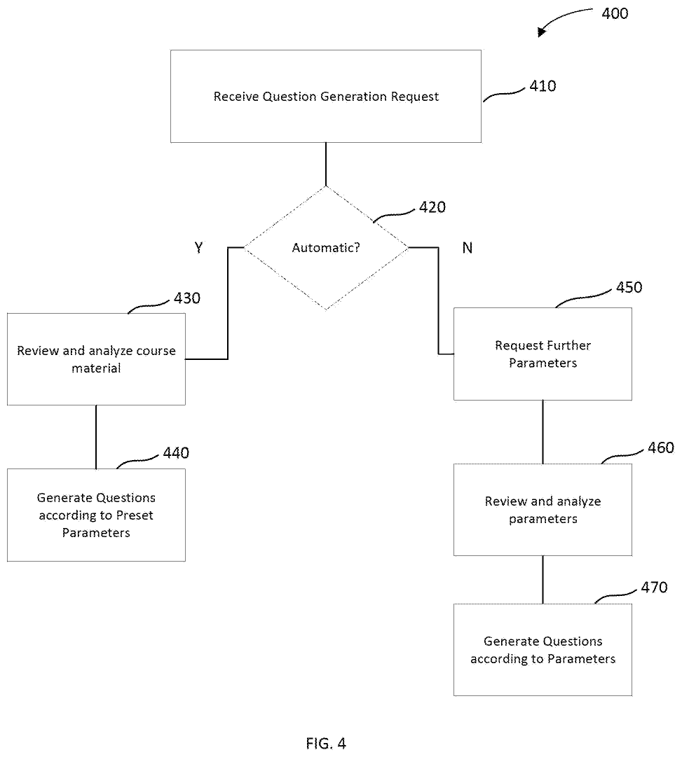

FIG. 4 is a flowchart illustrating a method 400 for question generation according to an embodiment. The method starts when the question generation system 80 receives a request to begin generating questions at 410. Typically, the request will include information about the course for which the questions are to be generated. The question generation system 80 then determines if the questions should be generated automatically at 420, for example, based on user input, a preconfigured setting, or the like. If the questions are to be generated automatically, the question configuration module 85, via the automatic question setting module 90, reviews and analyzes the relevant course material at 430. The automatic question setting module 90 then uses the analysis and preset parameters to automatically generate the questions at 440. It will be understood that the preset parameters may include question type(s), number of questions, level of questions, number or level of each type of questions, and other appropriate parameters. A user may also have the option of changing the parameters, in advance, afterward or in real-time.

If the question generation system 80 determines that the question generation is not automatic, the question configuration module 85, via the semi-automatic question setting module 95, requests further parameters at 450. As noted above, the parameters may include question type(s), number of questions, level of questions, number or level of each type of questions, and other appropriate parameters. At 460, the semi-automatic question setting module 95 reviews and analyzes the relevant parameters. Then, at 470, the semi-automatic question setting module 95 uses the analysis and parameters to generate the questions.

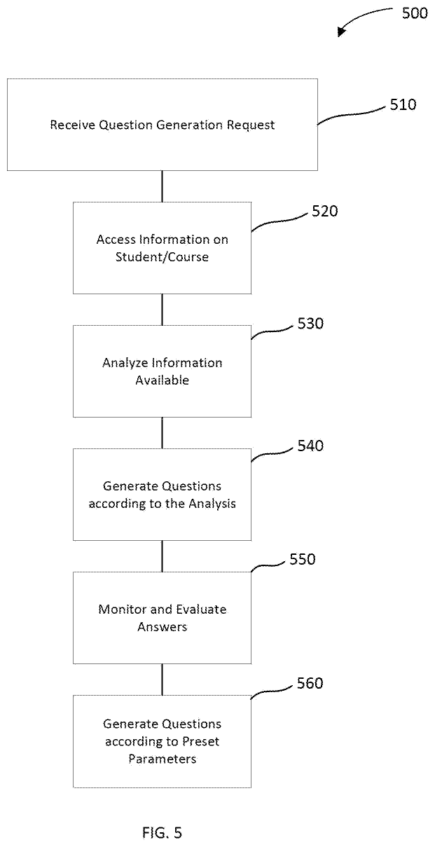

FIG. 5 is a flowchart illustrating a method 500 for question generation according to an embodiment. The method starts when the question generation system 80 receives a request to begin generating questions at 510. In this case, the request includes information about the student requesting the questions and about the course for which the questions are to be generated. The question generation system 80 then, via the real-time question module 110, accesses information about the student and course at 520, for example, the student's marks to date, the current section of the syllabus for the course, questions previously completed by the student, and the like. At 530, the real-time question module 110 analyzes the information available. Then, at 540, the real-time question module 110 generates questions based on the analysis. At 550, the student evaluation module 115 monitors and evaluates student answers to the questions as submitted. At 560, the student evaluation module 115 provides feedback to the student with regard to the answers submitted. The feedback may include corrections to the answer, additional resources for further review, or the like. In some cases, the student evaluation module 115 may save the questions provided to the student for future re-use to determine if the student has improved.

It will be understood that the methods illustrated in FIGS. 4 and 5 may be combined with, merged, with and/or draw elements from each method in various combinations and arrangements.

In the preceding description, for purposes of explanation, numerous details are set forth in order to provide a thorough understanding of the embodiments. However, it will be apparent to one skilled in the art that these specific details may not be required. In other instances, structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims below.

What is claimed is:

1. A method for automated question generation in a learning management system, the method comprising:
receiving a question generation request, wherein the question generation request relates to a course;
analyzing course material for the course related to the question generation request; and
generating questions based on the analysis and predetermined parameters.

2. A method for automated question generation according to claim 1, further comprising:
generating answers to the generated questions.

3. A method for automated question generation according to claim 1, further comprising:
prior to analyzing course material, determining if the question generation request is to be semi-automatic, and, if so, requesting parameters for question generation.

4. A method for automated question generation according to claim 1, wherein the question generation request comprises a student name, further comprising accessing information on the student.

5. A method for automated question generation according to claim 1, further comprising:
monitoring for answers to the generated questions;
evaluating the answers; and
providing feedback based on the evaluation of the answers.

6. A method for automated question generation according to claim 1, wherein the predetermined parameters can be adjusted after question generation and new questions will be generated.

7. A method for automated question generation according to claim 1, wherein the predetermined parameters include at least one of question types, number of questions, level of questions, and number or level of each type of question.

8. A method for automated question generation according to claim 1, wherein the analyzing the course material comprises determining the concepts and topics to be covered by the generated questions.

9. A system for automated question generation in a learning management system, the system comprising:
a processor;
a memory for storing computer readable instructions, which, when executed by the processor, generate the following modules:
a question generation system for receiving a question generation request, wherein the question generation request relates to a course;
a question configuration module for analyzing course material for the course related to the question generation request; and
an automatic question setting module for generating questions based on the analysis and predetermined parameters.

10. A system for automated question generation according to claim 9, wherein the automatic question setting module also generates answers to the generated questions.

11. A system for automated question generation according to claim 9, wherein the question generation system further determines if the question generation request is to be semi-automatic, and, if so, further includes a semi-automatic question setting module configured to request parameters for question generation.

12. A system for automated question generation according to claim 9, wherein the question generation request comprises a student name, further comprising a real-time question module configured to access information on the student.

13. A system for automated question generation according to claim 9, further comprising:
a real-time question module configured to:
monitor for answers to the generated questions;
evaluate the answers; and
provide feedback based on the evaluation of the answers.

14. A system for automated question generation according to claim 9, wherein the question generation system is configured so that predetermined parameters can be adjusted after question generation and new questions will be generated.

15. A system for automated question generation according to claim 9, wherein the predetermined parameters include at least one of question types, number of questions, level of questions, and number or level of each type of question.

16. A system for automated question generation according to claim 9, wherein the analyzing the course material comprises determining the concepts and topics to be covered by the generated questions.
